(19) United States
(12) Patent Application Publication
(10) Pub. No.: US 2006/0126543 A1
(43) Pub. Date: Jun. 15, 2006

(54) Mobile audiovisual device

(75) Inventor: Liu Pei Chung, Chungho (TW)

Correspondence Address: BIRCH STEWART KOLASCH & BIRCH, PO BOX 747, FALLS CHURCH, VA, 22040-0747, US

(73) Assignee: Magic Control Technology Corporation, Chungho (TW)

(21) Appl. No.: 11/011,058

(22) Filed: Dec. 15, 2004

(51) Int. Cl. H04B 7/00

(52) U.S. Cl. 370/310

(57) ABSTRACT

A mobile audiovisual device includes a central processing unit for operating information, a signal-processing unit connected to the central processing unit for receiving and processing external audio/video signals, a storage control unit connected to the central processing unit for receiving data from the signal-processing unit, and a transmission unit connected to the central processing unit for transmitting the processed external audio/video signals, so as to allow a user to browse required audiovisual data via the mobile audiovisual device in real time.

### FIELD OF THE INVENTION

The present invention relates to a mobile audiovisual device, and more particularly to a mobile audiovisual device via which a user is allowed to browse required audiovisual data in real time.

### BACKGROUND OF THE INVENTION

Generally, when a user wishes to browse required audiovisual data at any time, he or she has to store the required audiovisual data in a portable storage device, such as a removable hard disk, a USB drive mass storage device. etc., and then reads the required audiovisual data from the portable storage device as needed.

While the above-mentioned portable storage device allows a user to browse the audiovisual data stored therein at any time, it necessitates the user to store the audiovisual data in advance. Therefore, the portable storage device does not really allow the user to obtain some real-time audiovisual data. Moreover, most of the portable storage devices have a memory that has limited storing capacity and could not be used to store too many or too large audiovisual data files. Therefore, the currently available portable storage devices do not satisfy users in practical use thereof.

### SUMMARY OF THE INVENTION

A primary object of the present invention is to provide a mobile audiovisual device via which a user is allowed to browse required audiovisual data in real time.

To achieve the above and other objects, the mobile audiovisual device according to the present invention includes a central processing unit for operating information, a signal-processing unit electrically connected to the central processing unit for receiving and processing external audio/video signals, a storage control unit electrically connected to the central processing unit for receiving data from the signal-processing unit, and a transmission unit electrically connected to the central processing unit for transmitting the external audio/video signals having been processed by the signal-processing unit, so as to allow a user to browse required audiovisual data via the mobile audiovisual device in real time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows the architecture of a mobile audiovisual device according to the present invention; and

FIG. 2 schematically shows the manner of use of the mobile audiovisual device of the present invention.

### DETAILED DESCRIPTION OF THE PREFERRED EMBODIMENTS

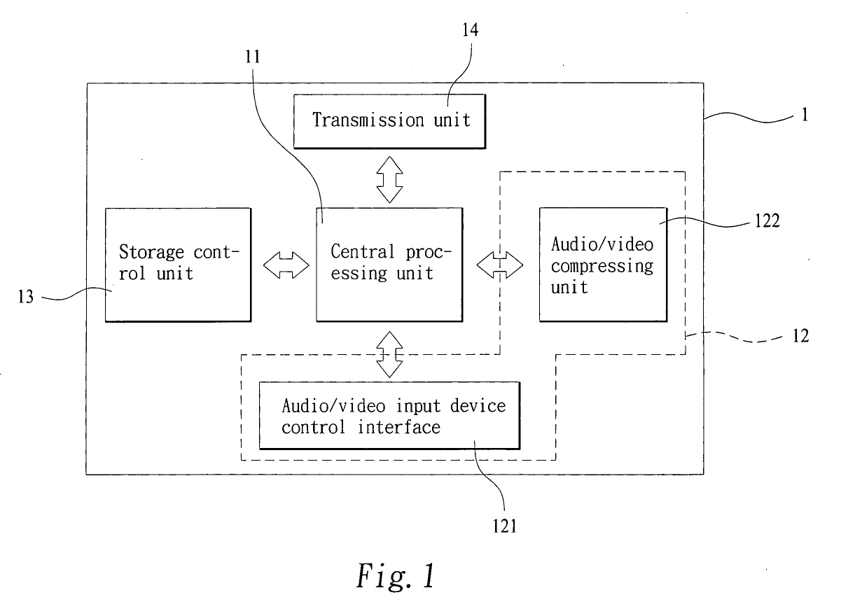

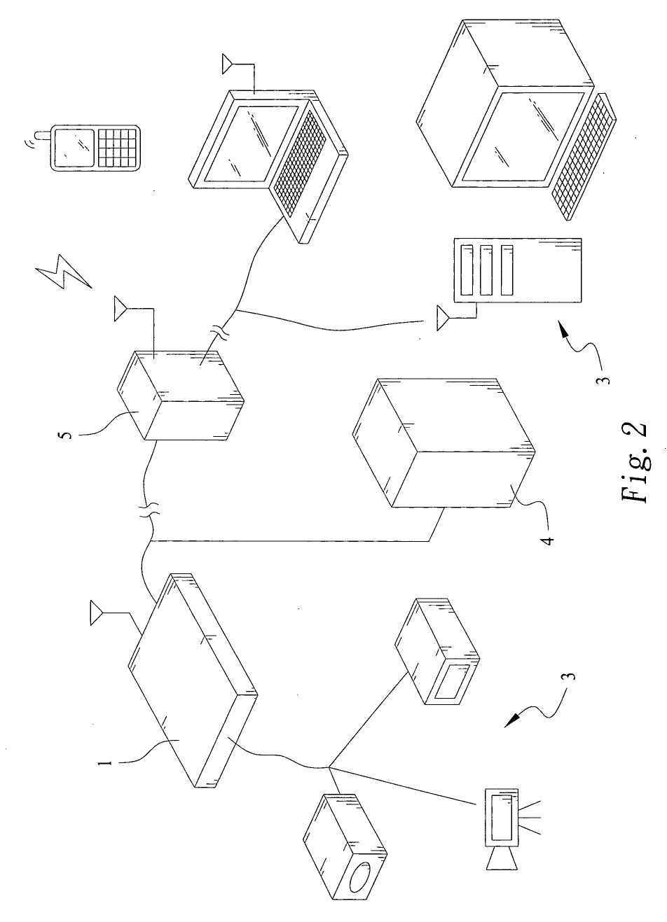

Please refer to FIGS. 1 and 2 that schematically show the architecture and the manner of use of a mobile audiovisual device 1 according to the present invention. As shown, the mobile audiovisual device 1 mainly includes a central processing unit 11, a signal-processing unit 12, a storage control unit 13, and a transmission unit 14. The mobile audiovisual device 1 is adapted to connect to external audiovisual equipment 2 and a display apparatus 3 to enable a user to browse required audiovisual data in real time via the mobile audiovisual device 1.

The central processing unit 11 operates information in the mobile audiovisual device 1.

The signal-processing unit 12 is electrically connected to the central processing unit 11 for receiving and processing audio and video signals from the external audiovisual equipment 2. The signal-processing unit 12 includes an audio/video input device control interface 121 for encoding external audio and video signals input thereto, and an audio/video compressing unit 122 for compressing the input external audio/video signals.

The storage control unit 13 is electrically connected to the central processing unit 11 for receiving data from the signal-processing unit 12.

The transmission unit 14 is electrically connected to the central processing unit 11 for transmitting the external audio/video signals that have been received and processed by the signal-processing unit 12. The transmission unit 14 may be designed for wireless transmission or wired transmission as shown in FIG. 2. Moreover, the transmission unit 14 may be further connected to a remote storage device 4.

The external audiovisual equipment 2 is electrically connected to the signal-processing unit 12 to provide required audio/video signals, and may be a digital camera, a video camera, a digital television set, or any other equipment capable of playing audio/video signals.

The display apparatus 3 is electrically connected to the transmission unit 14 for displaying audio/video signals transmitted from the transmission unit 14, and may be a notebook computer, a desktop computer, a mobile phone, or any other apparatus capable of displaying audio/video signals.

When it is desired to use the mobile audiovisual device of the present invention, first electrically connect the signal-processing unit 12 to the external audiovisual equipment 2, such as a digital camera, a video camera, a digital television set, etc., so that audio/video signals are transmitted from the external audiovisual equipment 2 to the signal-processing unit 12, which cooperates with the central processing unit 11 to encoding and compressing the received audio/video signals. The encoded and compressed audio/video signals are then sent from the central processing unit 11 to the storage control unit 13 for storage, or directly transmitted from the transmission unit 14 to a network browser 5 in a wireless or a wired manner using a real-time streaming protocol (RTSP). In the latter case, a user may enter at the display apparatus 3 a requested linking code to request a network linking system for a browser to be linked to, so as to browse in real time the required audiovisual data at the display apparatus 3, including a notebook computer, a desktop computer, a mobile phone, etc.

Alternatively, the audio/video signal data may be transmitted from the transmission unit 14 to the remote storage device 4 for storage. In this case, a user may, depending on actual need, enter at the display apparatus 3 a requested linking code to read the audio/video signal data stored in the remote storage device 4 via the network browser 5 at a later time. In this way, the user may still browse the required audiovisual data in real time.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A mobile audiovisual device, comprising:
a central processing unit for operating information;
a signal-processing unit electrically connected to said central processing unit for receiving and processing external audio/video signals input thereto;
a storage control unit electrically connected to said central processing unit for receiving data from said signal-processing unit; and
a transmission unit electrically connected to said central processing unit for transmitting said external audio/video signals that have been received and processed by said signal-processing unit.

2. The mobile audiovisual device as claimed in claim 1, wherein said signal-processing unit includes an audio/video input device control interface and an audio/video compressing unit.

3. The mobile audiovisual device as claimed in claim 2, wherein said audio/video input device control interface is adapted to encode said external audio/video signals input to said signal-processing unit.

4. The mobile audiovisual device as claimed in claim 2, wherein said audio/video compressing unit is adapted to compress said external audio/video signals input to said signal-processing unit.

5. The mobile audiovisual device as claimed in claim 1, wherein said signal-processing unit is adapted to electrically connect to external audiovisual equipment.

6. The mobile audiovisual device as claimed in claim 5, wherein said external audiovisual equipment is a digital camera.

7. The mobile audiovisual device as claimed in claim 5, wherein said external audiovisual equipment is a video camera.

8. The mobile audiovisual device as claimed in claim 5, wherein said external audiovisual equipment is a digital television set.

9. The mobile audiovisual device as claimed in claim 1, wherein said transmission unit transmits said processed external audio/video signals in a wireless manner.

10. The mobile audiovisual device as claimed in claim 1, wherein said transmission unit transmits said processed external audio/video signals in a wired manner.

11. The mobile audiovisual device as claimed in claim 1, wherein said transmission unit is adapted to electrically connect to a remote storage device.

12. The mobile audiovisual device as claimed in claim 1, wherein said transmission unit is adapted to electrically connect to a display apparatus.

13. The mobile audiovisual device as claimed in claim 12, wherein said display apparatus is a notebook computer.

14. The mobile audiovisual device as claimed in claim 12, wherein said display apparatus is a desktop computer.

15. The mobile audiovisual device as claimed in claim 12, wherein said display apparatus is a mobile phone.

16. A mobile audiovisual device, comprising:
a central processing unit for operating information;
a signal-processing unit electrically connected to said central processing unit for receiving and processing external audio/video signals input thereto;
a storage control unit electrically connected to said central processing unit for receiving data from said signal-processing unit;
a transmission unit electrically connected to said central processing unit for transmitting said external audio/video signals that have been received and processed by said signal-processing unit;
external audiovisual equipment electrically connected to said signal-processing unit for providing required audio/video signals; and
a display apparatus electrically connected to said transmission unit for displaying said audio/video signals transmitted from said transmission unit.

17. The mobile audiovisual device as claimed in claim 16, wherein said signal-processing unit includes an audio/video input device control interface and an audio/video compressing unit.

18. The mobile audiovisual device as claimed in claim 17, wherein said audio/video input device control interface is adapted to encode said external audio/video signals input to said signal-processing unit.

19. The mobile audiovisual device as claimed in claim 17, wherein said audio/video compressing unit is adapted to compress said external audio/video signals input to said signal-processing unit.

20. The mobile audiovisual device as claimed in claim 16, wherein said transmission unit is adapted to electrically connect to a remote storage device.
